(19) United States
(12) Patent Application Publication
(10) Pub. No.: US 2016/0342032 A1
(43) Pub. Date: Nov. 24, 2016

(54) Optical Alignment Film and Method for Preparing the Same, Display Substrate and Display Apparatus

(71) Applicants: BOE Technology Group Co., Ltd., Beijing (CN); Hefei Xinsheng Optoelectronics Technology Co., Ltd, Anhui (CN)

(72) Inventors: Liangliang Jiang, Beijing (CN); Yongcan Wang, Beijing (CN); Yong Jun Yoon, Beijing (CN); Quan Gan, Beijing (CN); Zhizhong Tu, Beijing (CN)

(21) Appl. No.: 15/137,756

(22) Filed: Apr. 25, 2016

(30) Foreign Application Priority Data
May 21, 2015 (CN) 201510263313.0

(51) Int. Cl. G02F 1/1337; B32B 27/28; B32B 3/30

(52) U.S. Cl. CPC G02F 1/133788; G02F 1/133723; B32B 3/30; B32B 27/281; G02F 2001/133715; G02F 2001/133776; B32B 2307/412; B32B 2457/202

(57) ABSTRACT

An optical alignment film and a method for preparing the same, a display substrate and a display apparatus are disclosed. The method includes: forming an optical alignment material film layer on a substrate; illuminating the optical alignment material film layer with interference light to expose the optical alignment material film layer and developing the illuminated optical alignment material film layer to form an optical alignment film having a groove structure of alternating concaves and convexes.

This application claims priority to and the benefit of Chinese Patent Application No. 201510263313.0 filed on May 21, 2015, which application is incorporated herein in its entirety.

### TECHNICAL FIELD

Embodiments of the present disclosure relate to an optical alignment film and a method for preparing the same, a display substrate and a display apparatus.

### BACKGROUND

There is a need to coat a layer of alignment film (the general component of which is polyimide (PI), abbreviated as a PI film) on the surface of the array substrate and the color film substrate prior to cell-assembling the array substrate and the color film substrate to form a display panel, and then a groove oriented in a certain direction is formed on the surface of the alignment film by a rubbing process. One rubbing alignment mode is that: rolling and rubbing the alignment film with a fluffy rubbing roller to form a pretilt angle of a unified direction, such that the liquid crystal molecules are inclined and arranged at a pretilt angle by the anchoring energy of the groove in an orderly direction. However, rubbing alignment will not only cause particle contamination to the alignment film and affect product yield, but also produce static electricity, which will damage the liquid crystal panel.

In order to overcome the aforesaid defects, much progress has been made to the development of optical alignment technology in the industry. Linearly polarized UV light is illuminated on the polymer alignment film having a photosensitizer. By photo-crosslinking, degradation or isomerization reaction, the alignment film generates an anisotropic distribution difference in the alignment region and the non-alignment region. The method may avoid particles and static electricity resulting from contact rubbing, and enable alignment of a small area. Nevertheless, it is quite complex to obtain linearly polarized UV light and hard to maintain the equipment. What's more, there are a limited number of control regions, the operation of which is complex and which is not convenient for the use of production lines.

### SUMMARY OF THE INVENTION

In a first aspect, embodiments of the present disclosure provide a method for preparing an optical alignment film, comprising: forming an optical alignment material film layer on a substrate; illuminating the optical alignment material film layer with interference light to expose the optical alignment material film layer and developing the illuminated optical alignment material film layer to form an optical alignment film having a groove structure of alternating concaves and convexes.

In a second aspect, embodiments of the present disclosure further provide an optical alignment film, which is prepared by the above method for preparing an optical alignment film.

In a third aspect, embodiments of the present disclosure further provide a display substrate, comprising the above optical alignment film.

In a fourth aspect, embodiments of the present disclosure further provide a display apparatus, comprising the above display substrate.

### BRIEF DESCRIPTION OF THE DRAWINGS

In order to clearly illustrate the technical solutions of the embodiments of the present disclosure, the drawings of the embodiments are briefly described below. Apparently, the drawings described below relate to only some embodiments of the present disclosure and thus are not limitative of the present disclosure.

FIG. 1 is a flow chart of a method for preparing an optical alignment film according to Embodiment 1.

FIG. 2 is a flow chart of a detailed method for preparing an optical alignment film according to Embodiment 1.

FIG. 3 is a flow chart of a detailed method for preparing an optical alignment film according to Embodiment 2.

FIG. 4 is a schematic view of the principle for forming interference light according to Embodiment 2.

FIG. 5 is a structural schematic view of an optical alignment film having a groove structure of alternating concaves and convexes according to the embodiments of the present disclosure.

### DETAILED DESCRIPTION

To make clearer the objects, technical solutions and advantages of the embodiments of the present disclosure, a clear and full description of the technical solutions of the embodiments of the present disclosure will be made with reference to the accompanying drawings of the embodiments of the present disclosure. Apparently, the described embodiments are just part rather than all of the embodiments of the present disclosure. Based on the embodiments of the present disclosure described, all the other embodiments obtained by a person of ordinary skill in the art, without any creative labor, fall within the scope of protection of the present disclosure.

Embodiments of the present disclosure provide a method for preparing an optical alignment film, a display substrate and a display apparatus, so as to solve the problem that the process of making an optical alignment film in the prior art is quite complex.

In order to solve the above technical problem, embodiments of the present disclosure provide the following technical solutions.

In a first aspect, embodiments of the present disclosure provide a method for preparing an optical alignment film, comprising: forming an optical alignment material film layer on a substrate; illuminating the optical alignment material film layer with interference light to expose the optical alignment material film layer and developing the illuminated optical alignment material film layer to form an optical alignment film having a groove structure of alternating concaves and convexes.

In some embodiments, “illuminating the optical alignment material film layer with interference light to expose the optical alignment material film layer and developing the illuminated optical alignment material film layer to form an optical alignment film having a groove structure of alternating concaves and convexes” comprises:

illuminating the optical alignment material film layer with interference light to form bright interference fringes and dark interference fringes which are alternating on the optical alignment material film layer, wherein the optical alignment material film layer corresponding to the bright interference fringes is decomposed and the optical alignment material film layer corresponding to the dark interference fringes is retained;

cleaning the optical alignment material film layer after being illuminated with interference light and removing the part of the optical alignment material film layer which is illuminated and decomposed by interference light to form an optical alignment film having a groove structure of alternating concaves and convexes.

In some embodiments, the method further comprises: prior to illuminating the optical alignment material film layer with interference light, forming the interference light with an interference light forming device, the interference light forming device comprises a light source, a first light-transmissive plate and a second light-transmissive plate which are disposed sequentially, the first light-transmissive plate having a slit and the second light-transmissive plate having two slits spaced apart by a preset distance, wherein the light generated by the light source forms the interference light after passing through the slit of the first light-transmissive plate and then through the two slits of the second light-transmissive plate.

In some embodiments, “illuminating the optical alignment material film layer with interference light to expose the optical alignment material film layer and developing the illuminated optical alignment material film layer to form an optical alignment film having a groove structure of alternating concaves and convexes” comprises:

illuminating the optical alignment material film layer with the interference light formed using the interference forming device to form bright interference fringes and dark interference fringes which are alternating on the optical alignment material film layer, where the sum of width of a bright interference fringe and a dark interference fringe is x=L*λ/d; wherein the optical alignment material film layer corresponding to the bright interference fringes is decomposed and the optical alignment material film layer corresponding to the dark interference fringes is retained;

cleaning the optical alignment material film layer after being illuminated with interference light and removing the part of the optical alignment material film layer which is illuminated and decomposed by interference light to form an optical alignment film of a groove structure of alternating concaves and convexes with a period of x;

wherein λ is the wavelength of the light generated by the light source, L is the distance between the second light-transmissive plate and the optical alignment material film layer, and d is the distance between the two slits on the second light-transmissive plate.

In some embodiments, the wavelength λ of the light generated by the light source is 200 nm to 400 nm.

In some embodiments, the optical alignment material film layer is a polyimide film layer having photosensitivity.

In some embodiments, a polyimide solution having photosensitivity on the substrate and curing the polyimide solution is coated and cured to form the optical alignment material film layer on the substrate.

In some embodiments, the cleaning is performed by a method selected from the group consisting of ultrasonic cleaning, atmospheric pressure plasma cleaning, immersion cleaning, and spray cleaning.

In some embodiments, the cleaning agent used for the cleaning comprises one or more selected from the group consisting of an aqueous ozone solution, an aqueous fluorine solution, an aqueous chlorine solution, an aqueous bromine solution, an aqueous iodine solution, hydrogen peroxide, water, ethanol, isopropanol, ethyl lactate, and propylene glycol methyl ether acetate.

In some embodiments, the interference light is ultraviolet interference light.

In a second aspect, embodiments of the present disclosure further provide an optical alignment film, which is prepared by the above method for preparing an optical alignment film.

In a third aspect, embodiments of the present disclosure further provide a display substrate, comprising the above optical alignment film.

In a fourth aspect, embodiments of the present disclosure further provide a display apparatus, comprising the above display substrate.

As can be seen from the aforesaid technical solutions, with the method for preparing an optical alignment film as described in the embodiments of the present disclosure, optical alignment is achieved by illuminating the optical alignment material film layer with interference light and the optical alignment film is formed, where the process is simple and easy to carry out at a low cost.

Regarding the method for preparing an optical alignment film as described in the embodiments of the present disclosure, there is no need to prepare linearly polarized light and optical alignment can be performed by using conventional light. The apparatus and procedure are simple and the process is easy to carry out; and the control precision is high. During practical applications, an optical alignment film with a different guide structure can be obtained by adjusting the variation of the periodic amplitude (light intensity) of light according to the light interference principle.

The method for preparing an optical alignment film as described in the embodiments of the present disclosure avoids the problems of dust particles and electrostatic discharge ESD resulting from rubbing orientation processes, and also avoids the problems that the manufacture of linearly polarized UV light in conventional light alignment is complex, the maintenance of apparatus is difficult, the control regions are limited and operation thereof is complicated.

The present disclosure comprises the following content.

Embodiment 1. A method for preparing an optical alignment film, comprising: forming an optical alignment material film layer on a substrate; illuminating the optical alignment material film layer with interference light to expose the optical alignment material film layer and developing the illuminated optical alignment material film layer to form an optical alignment film having a groove structure of alternating concaves and convexes.

Embodiment 2: The method according to Embodiment 1, wherein illuminating the optical alignment material film layer with interference light to form bright interference fringes and dark interference fringes which are alternating on the optical alignment material film layer, where the optical alignment material film layer corresponding to the bright interference fringes is decomposed and the optical alignment material film layer corresponding to the dark interference fringes is retained; cleaning the optical alignment material film layer after being illuminated with interference light and removing the part of the optical alignment material film layer which is illuminated and decomposed by interference light to form an optical alignment film having a groove structure of alternating concaves and convexes.

Embodiment 3. The method according to Embodiment 1, wherein illuminating the optical alignment material film layer with interference light to form bright interference fringes and dark interference fringes which are alternating on the optical alignment material film layer, where the optical alignment material film layer corresponding to the bright interference fringes is retained and the optical alignment material film layer corresponding to the dark interference fringes is decomposed; cleaning the optical alignment material film layer after being illuminated with interference light and removing the part of the optical alignment material film layer which is illuminated and decomposed by interference light to form an optical alignment film having a groove structure of alternating concaves and convexes.

Embodiment 4. The method according to Embodiment 1, wherein the interference light is formed as follows: forming the interference light with an interference light forming device, the interference light forming device comprises a light source, a first light-transmissive plate and a second light-transmissive plate which are disposed sequentially, the first light-transmissive plate having a slit and the second light-transmissive plate having two slits spaced apart by a preset distance d, wherein the light generated by the light source forms the interference light after passing through the slit of the first light-transmissive plate and then through the two slits of the second light-transmissive plate.

Embodiment 5. The method according to Embodiment 4, wherein a sum of width of a bright interference fringe and a dark interference fringe which are adjacent is x=L*λ/d; wherein x is a period of the groove structure of alternating concaves and convexes; λ is a wavelength of the light generated by the light source, L is a distance between the second light-transmissive plate and the optical alignment material film layer, and d is a distance between the two slits on the second light-transmissive plate.

Embodiment 6. The method according to Embodiment 5, wherein the wavelength λ of the light generated by the light source is 200 nm to 400 nm.

Embodiment 7. The method according to Embodiment 1, wherein the optical alignment material film layer is a polyimide film layer having photosensitivity.

Embodiment 8. The method according to Embodiment 7, wherein forming an optical alignment material film layer on a substrate comprises: coating a polyimide solution having photosensitivity on the substrate and curing the polyimide solution.

Embodiment 9. The method according to Embodiment 2, wherein the cleaning is performed by a method selected from the group consisting of ultrasonic cleaning, atmospheric pressure plasma cleaning, immersion cleaning, and spray cleaning.

Embodiment 10. The method according to Embodiment 2, wherein a cleaning agent used for the cleaning comprises one or more selected from the group consisting of an aqueous ozone solution, an aqueous fluorine solution, an aqueous chlorine solution, an aqueous bromine solution, an aqueous iodine solution, hydrogen peroxide, water, ethanol, isopropanol, ethyl lactate, and propylene glycol methyl ether acetate.

Embodiment 11. The method according to Embodiment 1, wherein the interference light is ultraviolet interference light.

Embodiment 12. The method according to Embodiment 2, wherein the optical alignment material film layer comprises a photodegradation reaction material.

Embodiment 13. The method according to Embodiment 12, wherein the photodegradation reaction material has the formula (1):

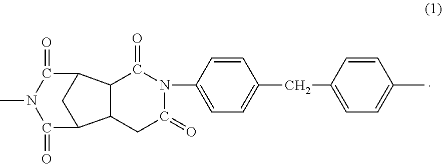

Embodiment 14. The method according to Embodiment 3, wherein the optical alignment material film layer comprises a material capable of photopolymerization reaction.

Embodiment 15. The method according to Embodiment 14, wherein the material capable of photopolymerization reaction has the formula:

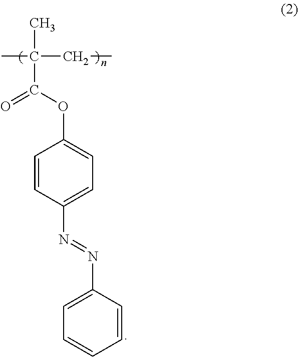

Embodiment 16. An optical alignment film, prepared by the method for preparing an optical alignment film according to Embodiment 1.

Embodiment 17. A display substrate, comprising the optical alignment film according to Embodiment 16.

Embodiment 18. A display apparatus, comprising the display substrate according to Embodiment 17.

Embodiment 19. The display apparatus according to Embodiment 18, which is at least one selected from the group consisting of a mobile phone, electronic paper, a tablet computer, a display, a camera, a TV set and a navigator.

### Embodiment 1

FIG. 1 is flow chart of a method for preparing an optical alignment film according to

Embodiment 1. As shown in FIG. 1, the method for preparing an optical alignment film according to Embodiment 1 comprises the steps of 101 and 102.

Step 101: forming an optical alignment material film layer on a substrate.

In the present step 101, the optical alignment material film layer is a polyimide film layer having photosensitivity, wherein, for example, the polyimide solution having photosensitivity is coated on the substrate and is cured to form the optical alignment material film layer.

Step 102: illuminating the optical alignment material film layer with interference light and removing the part of the optical alignment material film layer which is illuminated and decomposed by interference light to form an optical alignment film having a groove structure of alternating concaves and convexes.

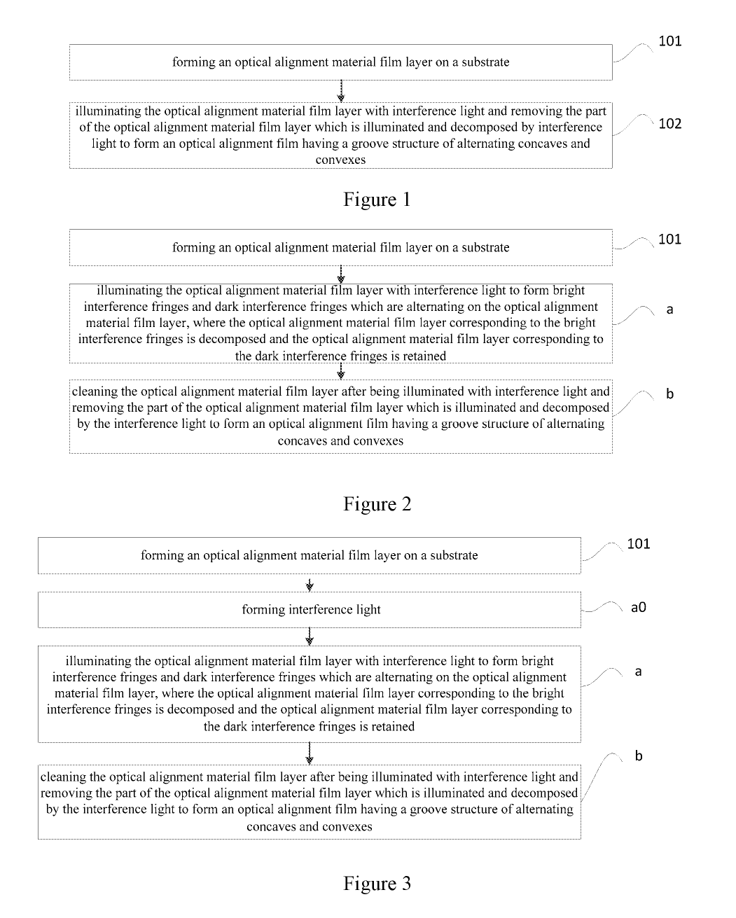

Referring to FIG. 2, in the present step 102, the following two sub-steps a and b are comprised.

a. illuminating the optical alignment material film layer with interference light to form bright interference fringes and dark interference fringes which are alternating on the optical alignment material film layer, where the optical alignment material film layer corresponding to the bright interference fringes is decomposed and the optical alignment material film layer corresponding to the dark interference fringes is retained.

In the present step a, while illuminating the optical alignment material film layer with interference light, for example, UV interference light is used.

In some embodiments, the optical alignment material film layer comprises a photodegradation reaction material, for example, N-arylamide, which may have the following formula (1):

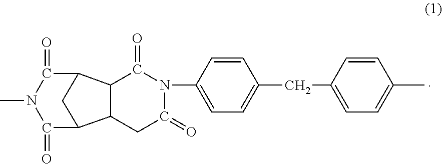

In some embodiments, while illuminating the optical alignment material film layer with interference light, depending upon the characteristics of the material of the optical alignment material film layer, the case may also be that the optical alignment material film layer corresponding to the bright interference fringes is retained and the optical alignment material film layer corresponding to the dark interference fringes is decomposed. In some embodiments, the optical alignment material film layer comprises a photodegradation reaction material, for example, an azo substance, which may have the following formula (2):

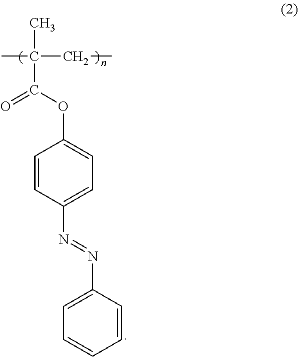

b. cleaning the optical alignment material film layer after being illuminated with the interference light and removing the part of the optical alignment material film layer which is illuminated and decomposed by the interference light to form an optical alignment film having a groove structure of alternating concaves and convexes.

In step b, after the optical alignment material film layer has been illuminated with interference light, part of the region is decomposed and part of the region is retained. Therefore, there is a need to clean the optical alignment material film layer and remove the part of the optical alignment material film layer which is illuminated and decomposed by interference light to form an optical alignment film having a groove structure of alternating concaves and convexes.

When cleaning the optical alignment material film layer, a method selected from the group consisting of ultrasonic cleaning, atmospheric pressure plasma cleaning, immersion cleaning, and spray cleaning may be employed. Upon cleaning, one or more cleaning agents selected from the group consisting of an aqueous ozone solution, an aqueous fluorine solution, an aqueous chlorine solution, an aqueous bromine solution, an aqueous iodine solution, hydrogen peroxide, water, ethanol, isopropanol, ethyl lactate, and propylene glycol methyl ether acetate may be used.

With the method for preparing an optical alignment film according to the present embodiment, the optical alignment material film layer is illuminated with interference light and bright interference fringes and dark interference fringes are formed which are alternating on the optical alignment material film layer by virtue of the characteristics of the interference light itself, where the region to which the bright interference fringes correspond indicate that the light intensity is strong and the region to which the dark interference fringes correspond indicate that the light intensity is weak. The optical alignment material film layer is decomposed by illumination in the region to which the bright interference fringes correspond and the optical alignment material film layer is retained in the region to which the dark interference fringes correspond due to the weak light intensity, so that an optical alignment film having a groove structure of alternating concaves and convexes is formed on the optical alignment film layer. That is, with the method for preparing an optical alignment film according to the present embodiment, the optical alignment material film layer is illuminated with interference light by virtue of the characteristics of the interference light itself and strong and weak light intensities which alternate on the optical alignment material film layer are formed. Since the optical alignment material film layer has photosensitivity, the optical alignment material film layer forms an optical alignment film having a groove structure of alternating concaves and convexes. By attaching the optical alignment film to an array substrate and a color filter substrate, the arrangement of liquid crystal molecules between the array substrate and the color film substrate can be induced by the groove structure of alternating concaves and convexes.

With the method for preparing an optical alignment film according to the present embodiment, optical alignment is achieved by illuminating the optical alignment material film layer with interference light and the optical alignment film is formed, where the process is simple and easy to carry out at a low cost. The method for preparing an optical alignment film according to the present embodiment avoids the problems of dust particles and electrostatic discharge ESD resulting from rubbing orientation processes, and also avoids the problems that the manufacture of linearly polarized UV light in conventional light alignment is complex, the maintenance of apparatus is difficult, the control regions are limited and operation thereof is complicated.

### Embodiment 2

On the basis of Embodiment 1, Embodiment 2 provides a more specific example to further describe the particular process of the above method for preparing an optical alignment film.

Referring to FIG. 3, prior to illuminating the optical alignment material film layer with interference light, the above step a further comprises the following step a0.

Step a0: forming interference light.

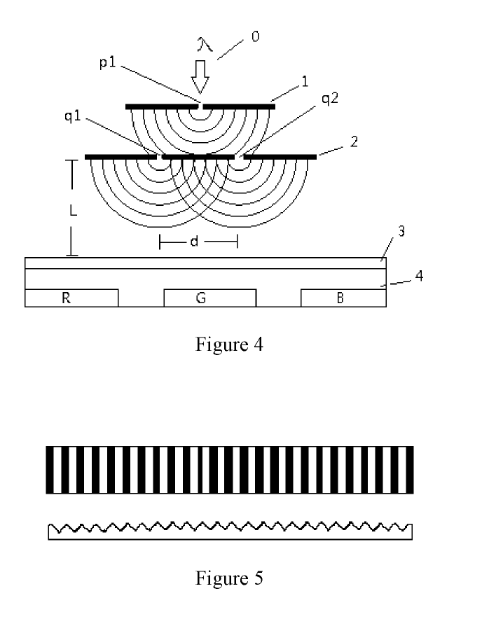

In the present step a0, the interference light forming device as shown in FIG. 4 can be used to form interference light.

Referring to FIG. 4, the interference light forming device comprises a light source 0, a first light-transmissive plate 1 and a second light-transmissive plate 2 which are disposed sequentially, the first light-transmissive plate 1 having a slit p1 at its center and the second light-transmissive plate 2 having two slits ql and q2 spaced apart by a preset distance, wherein the wavelength of the light generated by the light source 0 is λ, and the distance between the two slits q1 and q2 is d.

In accordance with the interference principle, the light generated by the light source 0 forms parallel light after passing through the slit p1 of the first light-transmissive plate 1, and the parallel light also passes through the two slits q1 and q2 of the second light-transmissive plate 2 to form two sub-beams of light. Since the two sub-beams of light are from two wave sources with the same vibration, they involve superposition and attenuation (mutual interference) of light intensity behind the second light-transmissive plate 2 due to the optical path difference, thereby forming interference light.

The optical alignment material film layer 3 is placed at a place spaced from the second light-transmissive plate 2 by a distance L, wherein the optical alignment material film layer 3 is disposed on a color film substrate 4 (FIG. 4 is exemplified by disposing the optical alignment material film layer 3 on the surface of a color film substrate 4 or on the surface of an array substrate). As shown in FIG. 4 and FIG. 5, the interference light formed by the interference light forming device illuminates the optical alignment material film layer such that it forms bright interference fringes and dark interference fringes which are alternating on the optical alignment material film layer. When the distance difference between a place on the optical alignment material film layer and the two slits q1 and q2 is several times (which is an integer) the wavelength (the wavelength of the light emitted from the light source), the wave crests of the above two sub-beams of light are superimposed and the wave troughs are superimposed to form a bright interference fringe. When the distance difference between a place on the optical alignment material film layer and the two slits ql and q2 is several times (which is an odd number) the half-wavelength, the wave crests and wave troughs of the above two sub-beams of light are superimposed and the amplitude (light intensity) of the light wave offsets each other to form a dark interference fringe.

The sum of width of a bright interference fringe and a dark interference fringe within one period is x=L*λ/d (i.e., the light intensity amplitude of the interference light varies on the optical alignment material film layer within the x cycle), wherein the optical alignment material film layer corresponding to the bright interference fringe is decomposed and the optical alignment material film layer corresponding to the dark interference fringe is retained, which finally induce the optical alignment material film layer to a corresponding orientation, thereby forming a groove arrangement of concaves and convexes.

After illumination with interference light, the optical alignment material film layer illuminated with interference light is cleaned and the part of the optical alignment material film layer which is illuminated and decomposed by interference light is removed to form an optical alignment film having a groove structure of alternating concaves and convexes with a period of x.

For example, the wavelength λ of the light generated by the light source is 200 nm to 400 nm. For example, L can be 50 μm to 200 μm; d can be 200 to 1000 μm; x can be 10 to 100 μm.

Admittedly, FIG. 4 merely illustrates a device for generating interference light, and the principle that the interference light enables the optical alignment material film layer to form an alignment film having a groove structure of concaves and convexes is exemplified herein. The present disclosure is not limited to the interference light generated by the device as shown in FIG. 4, and any other device which can generate interference light can be applied to the present disclosure.

With the method for preparing an optical alignment film according to the present embodiment, optical alignment is achieved by illuminating the optical alignment material film layer with interference light, and an optical alignment film having a groove structure of alternating concaves and convexes with a period of x is formed. As for the preparation of an optical alignment film by the method according to the present embodiment, there is no need to prepare linearly polarized light (UV light) and optical alignment can be performed using conventional light. The apparatus and procedure are simple and the process is easy to carry out; and the control precision is high. During practical applications, an optical alignment film with a different guide structure can be obtained by adjusting the variation of the periodic amplitude (light intensity) of light (UV) according to the light interference principle. For example, an optical alignment film having a different guide structure can be obtained by changing the above parameters L, λ and/or d. The method for preparing an optical alignment film as described in the embodiments of the present disclosure avoids the problems of dust particles and electrostatic discharge ESD resulting from rubbing orientation processes, and also avoids the problems that the manufacture of linearly polarized UV light in conventional light alignment is complex, the maintenance of apparatus is difficult, the control regions are limited and operation thereof is complicated.

### Embodiment 3

Embodiment 3 provides an optical alignment film, which is prepared by the method for preparing an optical alignment film according to the above Embodiment 1 or Embodiment 2.

The optical alignment film according to the present embodiment is prepared by the method for preparing an optical alignment film according to the above Embodiment 1 or Embodiment 2. Therefore, the preparation period of the optical alignment film is shortened and the preparation cost is reduced. As a consequence, the production yield of the optical alignment film is increased and the cost is reduced.

### Embodiment 4

Embodiment 4 provides a display substrate comprising the optical alignment film according to the above Embodiment 3.

The display substrate according to the present embodiment comprises an array substrate and a color film substrate which are cell-assembled, wherein the two opposite surfaces of the array substrate and the color film substrate are both coated with a layer of the above optical alignment film. The optical alignment film induces the liquid crystal directional alignment between the array substrate and the color film substrate by a groove structure of alternating concaves and convexes.

The display substrate according to the present embodiment uses an optical alignment film prepared by the method for preparing an optical alignment film according to the above Embodiment 1 or Embodiment 2. As such, during the stage at which an optical alignment film of the display substrate is prepared, the preparation process is simple, the preparation efficiency is improved and the preparation cost is reduced, as a result of which, the preparation period of the display substrate is shortened, which improves production efficiency and reduces cost as well.

### Embodiment 5

Embodiment 5 provides a display apparatus comprising the display substrate according to the above Embodiment 4.

The display apparatus according to the present embodiment employs the display substrate according to the above embodiment. As such, during the stage at which an optical alignment film of the display apparatus is prepared, the preparation process is simple, the preparation efficiency is improved and the preparation cost is reduced, as a result of which, the preparation period of the display apparatus is shortened, which improves production efficiency and reduces cost as well.

The display apparatus according to the present embodiment may be any product or component having display function such as a mobile phone, electronic paper, a tablet computer, a display, a camera, a TV set and a navigator.

The above are merely exemplary embodiments of the present disclosure, and are not intended to limit the scope of protection of the present disclosure, which is yet determined by the appended claims.

The present application claims the priority of the Chinese patent application No. 201510263313.0 submitted on May 21, 2015, and the content disclosed in the above Chinese patent application is incorporated herein by reference as part of the present application.

What is claimed is:

1. A method for preparing an optical alignment film, comprising:
forming an optical alignment material film layer on a substrate;
illuminating the optical alignment material film layer with interference light to expose the optical alignment material film layer, and
developing the illuminated optical alignment material film layer to form an optical alignment film having a groove structure of alternating concaves and convexes.

2. The method according to claim 1, wherein
the optical alignment material film layer is illuminated with the interference light to form bright interference fringes and dark interference fringes which are alternating on the optical alignment material film layer, where the optical alignment material film layer corresponding to the bright interference fringes is decomposed and the optical alignment material film layer corresponding to the dark interference fringes is retained;
the optical alignment material film layer after being illuminated with the interference light is cleaned to remove a part of the optical alignment material film layer which is illuminated and decomposed by the interference light to form an optical alignment film having a groove structure of alternating concaves and convexes.

3. The method according to claim 1, wherein
the optical alignment material film layer is illuminated with the interference light to form bright interference fringes and dark interference fringes which are alternating on the optical alignment material film layer, where the optical alignment material film layer corresponding to the bright interference fringes is retained and the optical alignment material film layer corresponding to the dark interference fringes is decomposed;
the optical alignment material film layer after being illuminated with the interference light is cleaned to remove a part of the optical alignment material film layer which is illuminated and decomposed by the interference light to form an optical alignment film having a groove structure of alternating concaves and convexes.

4. The method according to claim 1, wherein the interference light is formed with an interference light forming device.

5. The method according to claim 4, wherein the interference light forming device comprises a light source, a first light-transmissive plate and a second light-transmissive plate disposed sequentially, the first light-transmissive plate having a slit and the second light-transmissive plate having two slits spaced by a preset distance d, wherein light generated by the light source forms the interference light after passing through the slit of the first light-transmissive plate and then through the two slits of the second light-transmissive plate.

6. The method according to claim 5, wherein
a sum of width of a bright interference fringe and a dark interference fringe which are adjacent is x=L*λ/d;
wherein x is a period of the groove structure of alternating concaves and convexes, λ is a wavelength of the light generated by the light source, L is a distance between the second light-transmissive plate and the optical alignment material film layer, and d is a distance between the two slits on the second light-transmissive plate.

7. The method according to claim 6, wherein the wavelength λ of the light generated by the light source is 200 nm to 400 nm.

8. The method according to claim 1, wherein the optical alignment material film layer is a polyimide film layer having photosensitivity.

9. The method according to claim 8, wherein a polyimide solution having photosensitivity on the substrate is coated and cured to form the optical alignment material film layer on the substrate.

10. The method according to claim 2, wherein the cleaning is performed by a method selected from the group consisting of ultrasonic cleaning, atmospheric pressure plasma cleaning, immersion cleaning, and spray cleaning.

11. The method according to claim 2, wherein a cleaning agent used for the cleaning comprises one or more selected from the group consisting of an aqueous ozone solution, an aqueous fluorine solution, an aqueous chlorine solution, an aqueous bromine solution, an aqueous iodine solution, hydrogen peroxide, water, ethanol, isopropanol, ethyl lactate, and propylene glycol methyl ether acetate.

12. The method according to claim 1, wherein the interference light is ultraviolet interference light.

13. The method according to claim 2, wherein the optical alignment material film layer comprises a photodegradation reaction material.

14. The method according to claim 13, wherein the photodegradation reaction material has the formula (1):

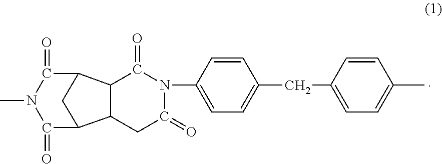

15. The method according to claim 3, wherein the optical alignment material film layer comprises a material capable of photopolymerization reaction.

16. The method according to claim 15, wherein the material capable of photopolymerization reaction has the formula:

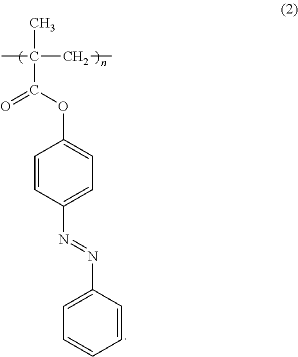

17. An optical alignment film, prepared by the method for preparing an optical alignment film according to claim 1.

18. A display substrate, comprising the optical alignment film according to claim 17.

19. A display apparatus, comprising the display substrate according to claim 18.

20. The display apparatus according to claim 19, which is at least one selected from the group consisting of a mobile phone, electronic paper, a tablet computer, a display, a camera, a TV set and a navigator.
